(19) United States
(12) Patent Application Publication
(10) Pub. No.: US 2026/0198468 A1
(43) Pub. Date: Jul. 16, 2026

(54) FISHING ASSISTANCE DEVICES, FISHING SYSTEMS, AND METHODS OF JIGGING

(71) Applicant: Ryan Schultz, DeMotte, IN (US)

(72) Inventor: Ryan Schultz, DeMotte, IN (US)

(21) Appl. No.: 19/447,681

(22) Filed: Jan. 13, 2026

Related U.S. Application Data
(60) Provisional application No. 63/744,947, filed on Jan. 14, 2025.

(51) Int. Cl. A01K 91/06; A01K 87/00; A01K 87/04

(52) U.S. Cl. CPC A01K 91/065; A01K 87/008; A01K 87/04

(57) ABSTRACT

Fishing assistance devices adapted to create a jigging action in a lure as a fishing line is reeled in, and fishing systems and methods utilizing such a fishing assistance device. Such a fishing assistance device includes a coupler configured to removably attach to a rod blank of a fishing rod at a location between a spinning reel and a first guide on the rod blank, and a guide arm supported by the coupler. The guide arm is configured to alter a path of the fishing line between the first guide and a bail of the spinning reel as the bail rotates around a spool of the spinning reel and winds the fishing line around the spool.

### CROSS-REFERENCE TO RELATED APPLICATIONS

This application claims priority to provisional U.S. Patent Application No. 63/744,947 filed Jan. 14, 2025, the contents of which are incorporated herein by reference

### BACKGROUND OF THE INVENTION

The present invention generally relates to a fishing equipment and methods. More particularly, the invention relates to fishing assistance devices adapted to removably attach to a fishing rod to interact with fishing line to create a jigging action of a lure as a fishing line is reeled in, and further relates to fishing systems and methods utilizing such fishing assistance devices.

Jigging mechanisms exist that are adapted to cause a lure at the end of a fishing line to move in a jigging motion without the need to move the entire fishing rod to create the jigging action. Such mechanisms, which can be designed for use on large bodies of water or ice fishing, are often large mechanical equipment that may be electrically powered.

It would be desirable if a fishing assistance device existed that was capable of being small, light-weight, and removably attachable to standard fishing rods for creating a jigging motion in a lure attached to the end of a fishing line.

### BRIEF SUMMARY OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides, but is not limited to, fishing assistance devices adapted to create a jigging action of a lure as a fishing line is reeled in, and fishing systems and methods utilizing such a fishing assistance device.

According to a nonlimiting aspect of the invention, a fishing assistance device is provided that is adapted for use in combination with a fishing rod having a rod blank, a spinning reel mounted on the rod blank, and a first guide mounted on the rod blank adjacent the spinning reel, the spinning reel including a spool, a fishing line on the spool and passing through the first guide, and a bail adapted to rotate around the spool to wind the fishing line around the spool. The fishing assistance device includes a coupler configured to removably attach to the rod blank at a location between the spinning reel and the first guide on the rod blank, and a guide arm supported by the coupler, the guide arm being configured to guide the fishing line so as to alter a path of the fishing line between the first guide and the bail of the spinning reel as the bail rotates around the spool and winds the fishing line around the spool.

According to another nonlimiting aspect of the invention, a fishing system includes a fishing rod and a fishing assistance device. The fishing rod has a rod blank, a spinning reel mounted on the rod blank, and a first guide mounted on the rod blank adjacent the spinning reel, the spinning reel including a spool, a fishing line on the spool and passing through the first guide, and a bail adapted to rotate around the spool to wind the fishing line around the spool. The fishing assistance device has a coupler removably attached to the rod blank at a location between the spinning reel and the first guide on the rod blank, and a guide arm that guides the fishing line relative to the rod blank in a manner that alters a path of the fishing line relative to the rod blank between the first guide and the bail as the bail is rotated around the spool and winds the fishing line around the spool.

According to yet another nonlimiting aspect of the invention, a method of jigging a fishing lure includes providing a fishing rod having a rod blank, a spinning reel mounted on the rod blank, and a first guide mounted on the rod blank adjacent the spinning reel, the spinning reel including a spool, a fishing line on the spool and passing through the first guide, and a bail adapted to rotate around the spool to wind the fishing line around the spool. A fishing assistance device is attached to the rod blank between the first guide and the spool and engages the fishing line with a guide arm of the fishing assistance device. Rotating a handle of the spinning reel causes the bail to rotate around the spool and reel in the fishing line. The guide arm of the fishing assistance device alters a path of the fishing line between the first guide and the bail as the bail rotates around the spool of the spinning reel to cause the fishing line to move in a jigging motion.

Technical aspects of fishing assistance devices, fishing systems, and methods as described above preferably include the ability to alter the path of a fishing line as the fishing line is being reeled in, causing a lure at the end of the fishing line to move in a jigging motion without the need to move the rod to create the jigging action. The fishing assistance devices are preferably light-weight, small, and removably attachable to standard fishing rods, and are preferably capable of being utilized or not utilized while the device remains attached to a fishing rod.

These and other aspects, arrangements, features, and/or technical effects will become apparent upon detailed inspection of the figures and the following description.

### BRIEF DESCRIPTION OF THE SEVERAL VIEWS OF THE DRAWING

FIG. 1 represents a side view of a fishing assistant device according to a nonlimiting embodiment of the present invention.

FIG. 2 schematically represents a fishing rod and spinning reel with the fishing assistant device of FIG. 1 attached to a rod blank of the rod so that a fishing line of the fishing rod travels along a variable path between the spinning reel and the fishing assistant device.

FIGS. 3A and 3B schematically represent a view taken along section line 3-3 of FIG. 2, and shows two locations of the bail of the spinning reel depicted in FIG. 2 that cause the fishing line to be disposed on two different paths represented in FIG. 2.

FIG. 4 schematically represents a view taken along section line 4-4 of FIG. 2, and shows the fishing line guided by a guide arm of the fishing assistance device.

FIG. 5 schematically represents a view similar to FIG. 4 but depicts a fishing assistant device according to another embodiment of the invention.

FIG. 6 represents a side view of a fishing assistant device according to another nonlimiting embodiment of the present invention, and FIGS. 7 through 10 represent various perspective views of the device of FIG. 6.

FIG. 11 schematically represents a fishing rod and spinning reel with the fishing assistant device of FIGS. 6 through 10 attached to a rod blank of the rod so that a fishing line of the fishing rod travels along a variable path between the spinning reel and the fishing assistant device.

### DETAILED DESCRIPTION OF THE INVENTION

The intended purpose of the following detailed description of the invention and the phraseology and terminology employed therein is to describe what is shown in the drawings, which include the depiction of and/or relate to one or more nonlimiting embodiments of the invention, and to describe certain but not all aspects of what is depicted in the drawings, including the embodiment(s) depicted in the drawings. The following detailed description also describes certain investigations relating to the embodiment(s) depicted in the drawings, and identifies certain but not all alternatives of the embodiment(s) depicted in the drawings. As nonlimiting examples, the invention encompasses additional or alternative embodiments in which one or more features or aspects shown and/or described as part of a particular embodiment could be eliminated. Therefore, the appended claims, and not the detailed description, are intended to particularly point out subject matter regarded to be aspects of the invention, including certain but not necessarily all of the aspects and alternatives described in the detailed description.

The drawings depict embodiments of fishing assistance devices and fishing systems comprising the devices mounted to fishing rods. The devices are operable to alter the path of a fishing line as the fishing line is being reeled in using a fishing rod in a manner that causes a lure at the end of the fishing line to move in a jigging motion without the need to move the rod to create the jigging action. The fishing assistance devices preferably do not interfere or obstruct the conventional operation of a fishing rod, in that a fishing rod can be operated while the device is attached thereto, whether or not the device is being utilized to induce a jigging motion in a lure.

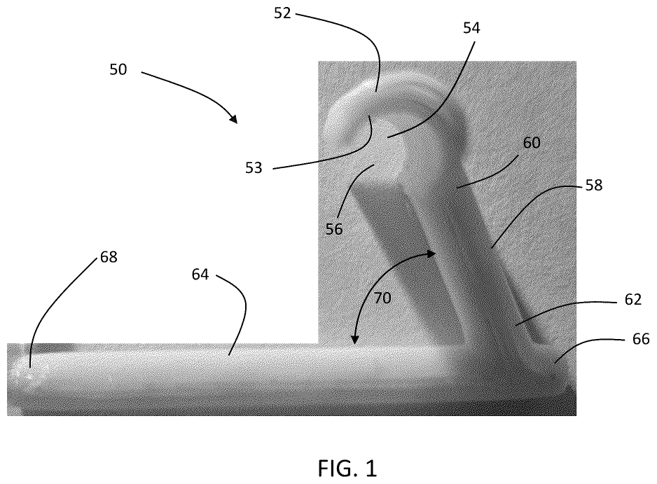

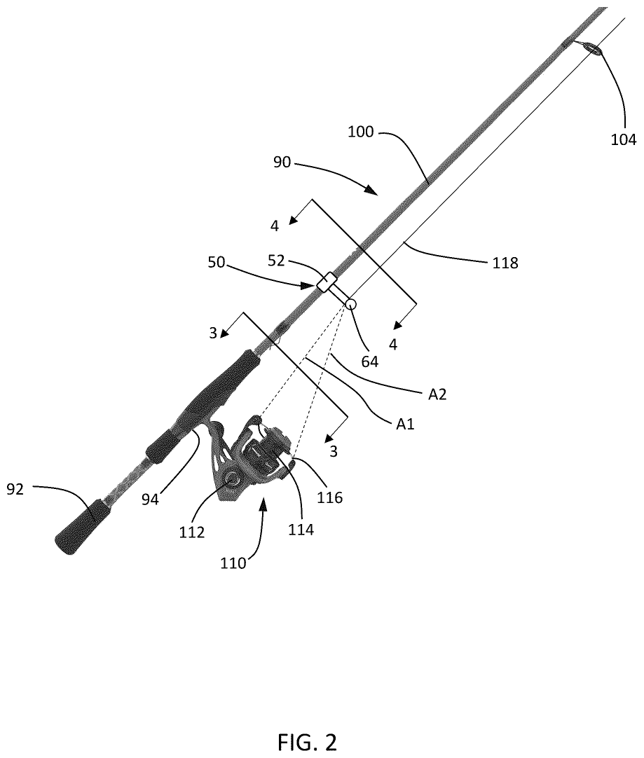

FIG. 1 represents a fishing assistance device 50 according to a first nonlimiting embodiment of the present invention, and FIGS. 2 through 5 represent the fishing assistance device 50 removably mounted to a rod blank 100 of a fishing rod (pole) 90 between a spinning reel 110 and a guide 104 located nearest the reel 110 on the rod blank 100. The fishing assistance device 50 includes a coupler 52 configured to be removably attached to the rod blank 100 of the fishing rod 90. As represented in FIG. 2, the coupler 52 is removably attached to the rod blank 100 at a location between a spinning reel 110 of the rod 90 and a first guide 104 on the rod 90 nearest the reel 110. The coupler 52 has an arcuate shape, represented as a circular arc shape having an arc length that is greater than 50% (greater than 180 degrees) of a circle, so that the coupler 52 defines an arcuate surface 53 that surrounds more than 50% of the circumference (more than 180 degrees) of an interior passage 54 of the coupler 52 and defines a radial access opening 56 to the interior passage 54 that has an arc length that is less than 50% of the circumference (less than 180 degrees) of the interior passage 54. The passage 54 is complementary in shape and size (diameter) to the rod blank 100 of the fishing rod 90 and the access opening 56 is slightly smaller than the diameter of the rod blank 100 to enable the coupler 52 to couple the device 50 to the rod blank 100 by inserting the rod blank 100 into the passage 54 through the access opening 56, after which the passage 54 snugly fits around the rod blank 100 to grip and secure the fishing assistance device 50 in place on the rod 90. Alternatively, the coupler 52 may be configured as a clamp or other gripping-type structure that permits the fishing assistance device 50 to be removably attached to the rod blank 100.

The device 50 further comprises a guide arm 64 supported by the coupler 52. As shown in FIG. 2, the guide arm 64 is positioned and configured relative to the rod blank 100 to be able to guide a fishing line 118 of the fishing rod 90 and in so doing alter the path of the fishing line 118 between the first guide 104 and a bail 116 of a spinning reel 110 mounted to the rod 90. The device 50 further but optionally includes a support arm 58 that interconnects the coupler 52 to the guide arm 64. A first end 60 of the support arm 58 adjoins the coupler 52 and a second end 62 of the support arm 58 adjoins the guide arm 64, such that the guide arm 64 is spaced apart from the rod blank 100 of the fishing rod 90 when the device 50 is coupled to the rod blank 100 with the coupler 52. The second end 62 of the support arm 58 adjoins the guide arm 64 at or adjacent a first end 66 of the guide arm 64. The guide arm 64 extends away from the guide arm 64 at an acute angle 70, terminating at a distal end 68 of the guide arm 64. The angle 70 between the support arm 58 and guide arm 64 is represented as about 68 degrees, though lesser and greater acute angles are foreseeable. The fishing assistance device 50 may be constructed from plastic, metal, or a composite and may be rigid or semi-rigid. As shown, the device 50 is a unitary piece, in other words, the coupler 52, support arm 58, and guide arm 64 are integrally formed together, such as by injection molding or three-dimensional (3D) printing, as opposed to being assembled together, though it is foreseeable that the device 50 could be fabricated as an assembly of parts.

In FIG. 2, the fishing assistance device 50 is connected to the rod blank 100 of the fishing rod 90 such that the support arm 58 extends in a transverse direction relative to an axis of the rod blank 100. Additionally, the guide arm 64 is shown as disposed beneath the rod blank 100 so as to be on the same side of the rod blank 100 as the spinning reel 110 and therefore positioned to engage the fishing line 118 of the reel 110.

Though the particular fishing rod 90 and spinning reel 110 are represented in FIG. 2 as a spinning rod with an open reel, the rod 90 and reel 110 may be of various different types commonly known and used for fishing. The fishing rod 90 includes a handle 92, a reel slot 94 for attaching the spinning reel 110, and the rod blank 100 with at least one guide 104 for guiding the fishing line 118 along the length of the rod blank 100. The spinning reel 110 includes a handle (crank) 112 for reeling in the fishing line 118. A spool 114 is located at the front of the spinning reel 110, and the bail 116 of the reel 110 is configured to rotate around the spool 114, guiding the fishing line 118 to wrap (wind) evenly and snugly around the spool 114. A roller 116A is carried on the bail 116 to retain the fishing line 118 on the bail 116 as the bail 116 rotates around the spool 114 and causes the fishing line 118 to follow a consistent circular path as the spool 114 oscillates in an axial direction thereof to create neat layers between the ends of the spool 114.

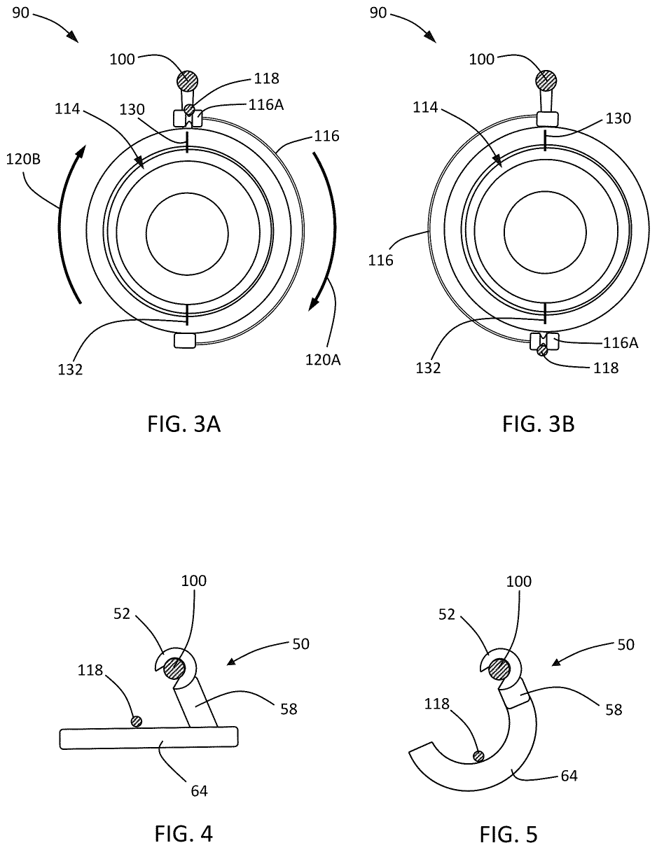

The guide arm 64 of the fishing assistance device 50 guides the fishing line 118 relative to the rod blank 100 in a manner that alters the path of the fishing line 118 relative to the rod blank 100 between the first guide 104 and bail 116 of the spinning reel 110 as the bail 116 rotates around the spool 114 and winds the fishing line 118 around the spool 114. FIG. 2 schematically represents the fishing line 118 at two different and nonparallel paths A1 and A2 (represented with broken lines) relative to the spool 114 due to the rotation of the spool 114 and the influence of the fishing assistance device 50. FIGS. 3A and 3B show the two different locations of the fishing line 118 relative to the spool 114 as a result of the rotation of the bail 116 and its roller 116A around the spool 114 as the fishing line 118 is wrapped around the spool 114 during retrieval of a lure (not shown) at the end of the fishing line 118.

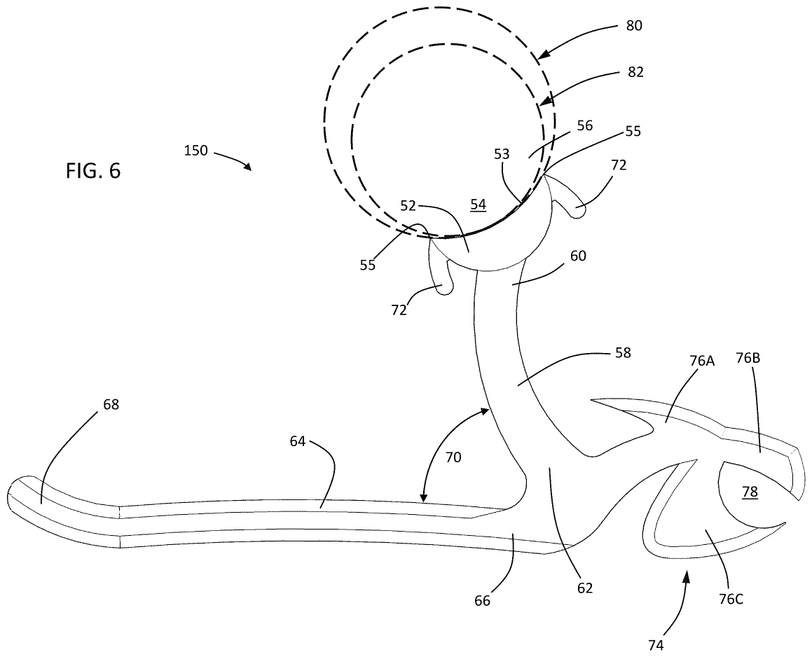

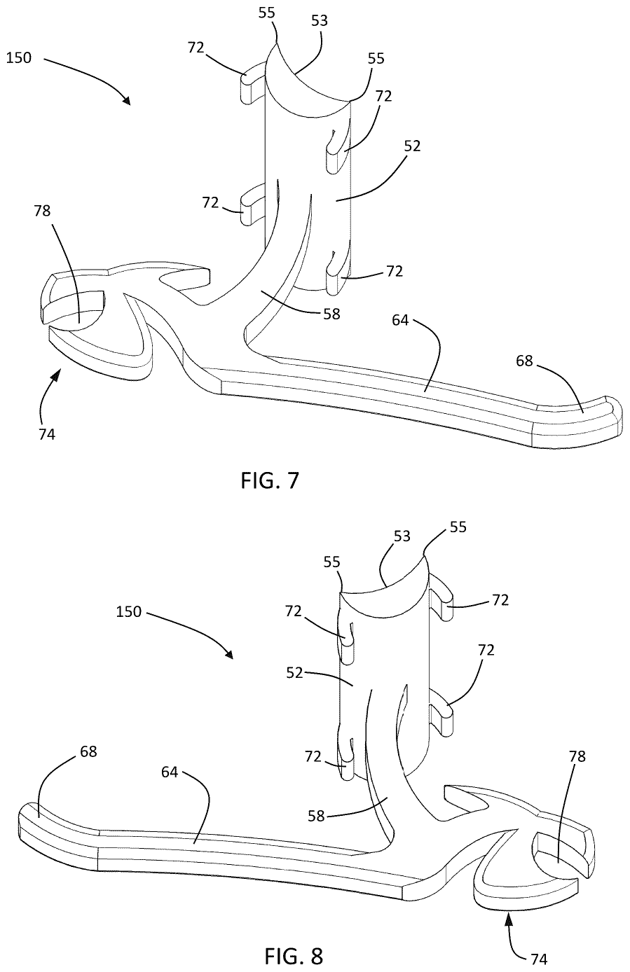

Taken together, FIGS. 2, 3A, and 3B depict the influence of the fishing assistance device 50 on the fishing line 118 of FIG. 2. As the bail 116 rotates around the spool 114, the roller 116A engages the fishing line 118 so that the fishing line 118 is sequentially located at a first circumferential location 130 relative to the spool 114 (FIG. 3A) and then a second circumferential location 132 relative to the spool 114 (FIG. 3B). The first circumferential location 130 (FIG. 3A) can be considered as located at top dead center of the spool 114 directly below and nearest to the rod blank 100, and the second circumferential location 132 (FIG. 3B) can be considered as located at bottom dead center of the spool 114 approximately 180 degrees from the first location 130 (and therefore farthest from the rod blank 100) in the clockwise direction (represented by arrows 120A and 120B). In both locations 130 and 132 and all locations therebetween, the fishing line 118 preferably resides within and continuously contacts the guide arm 64 of the fishing assistance device 50 as shown in FIG. 2, and causes the fishing line 118 to be deflected as seen in FIG. 2. This deflection continuously changes the path of the fishing line 118 between the nearest guide 104 and the bail 116 as the bail roller 116A rotates around the spool 114, as represented by the two different paths A1 and A2 represented in FIG. 2. This deflection causes the distance between the roller 116A and the nearest guide 104 to be slightly longer when the fishing line 118 is located on the path A2 than on the path A1. As a result, if the spool 114 is maintained at a constant rate of rotation as a lure is retrieved, the fishing line 118 must travel at a higher linear velocity when on the path A2 than when on the path A1, such that the velocity of the fishing line 118 gradually increases (accelerates) as the bail roller 116A (and the fishing line 118 guided by the roller 116A) travels from the first circumferential location 130 to the second circumferential location 132, represented by the arrow 120A, and the velocity of the fishing line 118 gradually decreases (decelerates) as the bail roller 116A (and the fishing line 118 guided by the roller 116A) travels from the second circumferential location 132 back to the first circumferential location 130, represented by the arrow 120B. The sequential acceleration and deceleration of the fishing line 118 during each individual rotation of the spool 114 create a jigging action on a lure at the end of the fishing line 118. Though described as being in continuous contact with the guide arm 64, it is foreseeable that the fishing line 118 may disengage the guide arm 64 when on the path A1 nearest the rod blank 100, creating slack in the fishing line 118 that may cause the lure to slow or momentarily stop moving while the spool 114 continues to rotate to retrieve the fishing line 118 and a lure attached thereto.

Whereas the fishing assistance device 50 is represented as having a generally V-shape in FIGS. 1 and 4, other shapes are foreseeable. For example, FIG. 5 represents an embodiment of the fishing assistance device 50 as having a generally U-or J-shape. With this configuration, the fishing line 118 is more likely to reside within and continuously contact the guide arm 64 of the fishing assistance device 50 at both extreme paths A1 and A2 and all locations therebetween.

In view of the above, it can be appreciated that an individual using the fishing assistance device 50 is able to cause a lure to jig by turning the handle 112 on the spinning reel 110 to cause the spool 114 to reel in the fishing line 118 without having to induce any movement of the rod blank 100. As the individual rotates the handle 112 on the spinning reel 110, the bail 116 and its roller 116A rotate around the spool 114 to reel in the fishing line 118 and wrap the fishing line 118 around the spool 114. During this time, the fishing line 118 is engaged by and contacts the guide arm 64 of the fishing assistance device 50, altering the path of the fishing line 118 between the spool 114 and nearest guide 104 such that the fishing line 118 oscillates between the two nonparallel paths A1 and A2 shown in FIG. 2. As the bail 116 rotates around the spool 114, guiding the fishing line 118 around the spool 114, the continuously changing path of the fishing line 118 causes a jigging motion of a lure attached to the line 118. From FIG. 2 it can be appreciated that the fishing assistance device 50 is capable of being utilized or not utilized while the device 50 remains attached to the fishing rod 90, for example, by simply disengaging the fishing line 118 from the guide arm 64 so that the fishing line 118 is held between the bail 116 and nearest guide 104 in a conventional manner.

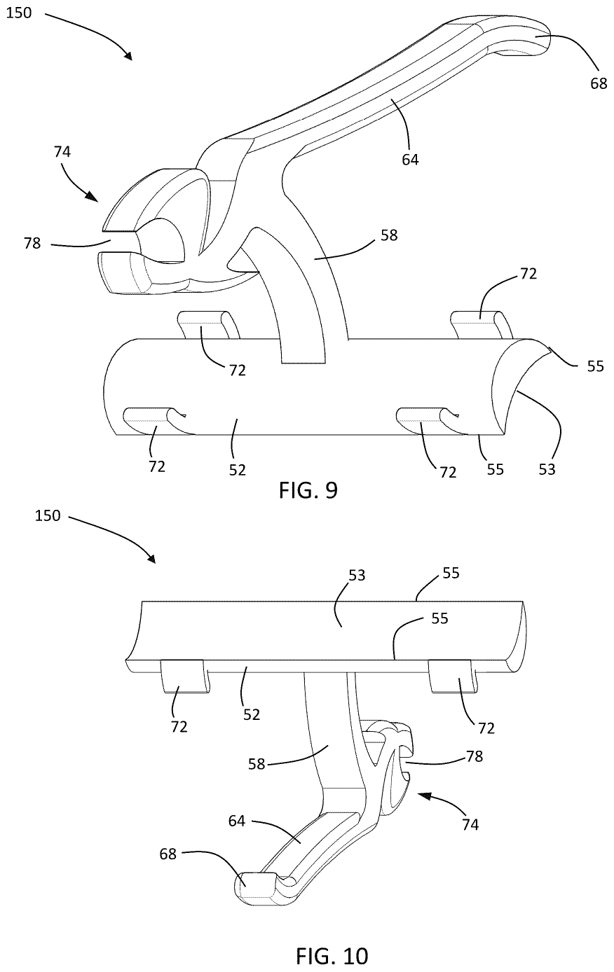

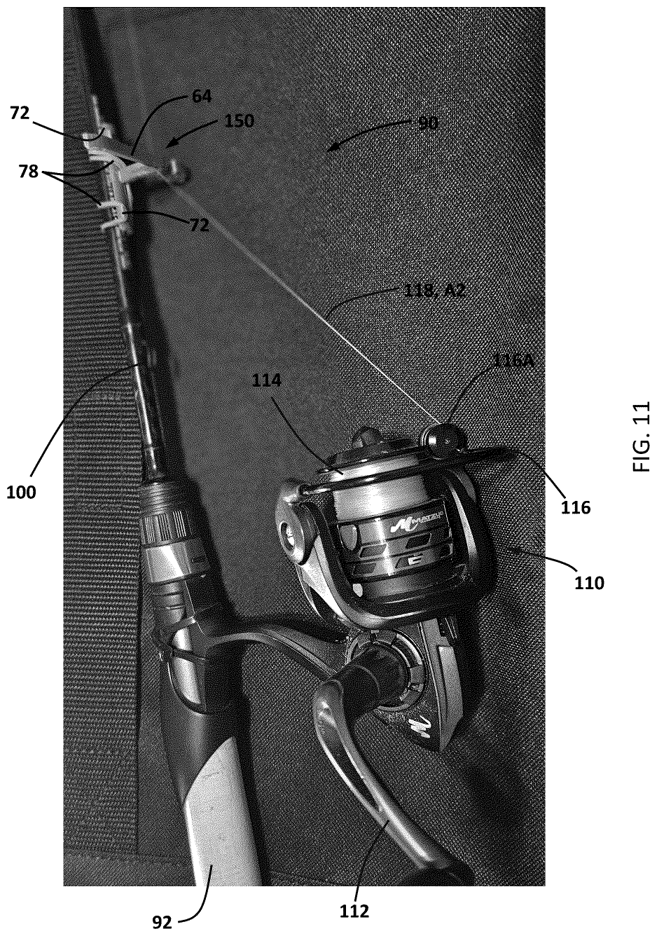

FIGS. 6 through 10 represent a fishing assistance device 150 according to a second nonlimiting embodiment of the present invention, and FIG. 11 represents the fishing assistance device 150 removably mounted to a rod blank 100 of a fishing rod 90 in a manner similar to what was shown and described in reference to FIG. 2. Though the nearest guide (104 in FIG. 2) is not shown in FIG. 11, it should be evident from FIG. 11 that, similar to the embodiment of FIG. 2, the fishing assistance device 150 is removably mounted to the rod blank 100 between the spinning reel 110 and the nearest guide located on the rod blank 100 of the rod 90. For convenience, identical reference numerals are used in FIGS. 6 through 11 to denote the same or functionally related/equivalent elements described for the device 50 of FIGS. 1 through 5. In view of similarities between the first and second embodiments depicted in the drawings, the following discussion of FIGS. 6 through 11 will focus primarily on aspects of the second embodiment that differ from the first embodiment in some notable or significant manner. Other aspects of the second embodiment not discussed in any detail can be, in terms of structure, function, materials, etc., essentially as was described for the first embodiment

Similar to the fishing assistance device 50 of FIGS. 1 through 5, the fishing assistance device 150 includes a coupler 52 configured to removably attach to the rod blank 100, a guide arm 64, and a support arm 58 that interconnects the coupler 52 to the guide arm 64. First and second ends 60 and 62 of the support arm 58 are adjoined to the coupler 52 and support arm 58, respectively, such that the guide arm 64 is spaced apart from the rod blank 100 when the device 50 is coupled to the rod 90 with the coupler 52. A first end 66 of the guide arm 64 is adjoined to the support arm 58 at or adjacent the second end 62 of the support arm 58, and the guide arm 64 extends away from the guide arm 64 at an acute angle 70, terminating at a distal end 68 of the guide arm 64.

Though adapted to removably attach the fishing assistance device 150 to a rod blank of a fishing rod, the coupler 52 of the device 150 has a different configuration than the coupler 52 for the device 50 of the first embodiment. The coupler 52 has an arcuate shape, represented as a circular arc shape having an arc length that is less than 50% (less than 180 degrees) of a circle 80 (represented by a dashed line in FIG. 6), so that the coupler 52 defines an arcuate surface 53 whose arc length is less than 50% (less than 180 degrees) of the circumference of an interior passage 54 of the coupler 52 and defines a radial access opening 56 to the interior passage 54 that has an arc length that is greater than 50% (greater than 180 degrees) of the circumference of the interior passage 54. The coupler 52 enables the device 150 to be mounted to a fishing rod 90 whose rod blank 100 has a shape and diameter that are essentially the same as the circle 80, in which case the arcuate surface 53 of the coupler 52 is able to be mated to and make surface contact with the rod blank 100 along the entire arc length of the arcuate surface 53. The coupler 52 also enables the device 150 to be mounted to a fishing rod 90 whose rod blank 100 has a shape and/or diameter that is different than the circle 80. For example, the arcuate surface 53 of the couple 52 is able to be mated to a smaller rod blank 100 represented by the circle 82 in FIG. 6, in which case the rod blank 100 will not contact the arcuate surface 53 along the entire arc length of the arcuate surface 53 and instead contact will be localized somewhere between lateral edges 55 of the arcuate surface 53. The arcuate surface 53 also enables the couple 52 to be mated to a larger rod blank 100, in which case contact will be localized at the lateral edges 55 of the arcuate surface 53.

Because the radial access opening 56 exceeds 180 degrees and thus the coupler 52 is not adapted to grip the rod blank 100 of a fishing rod 90, the coupler 52 is shown in FIGS. 6 through 11 as equipped with two pairs of opposing studs 72 located adjacent the lateral edges 55 of the arcuate surface 53. FIG. 11 depicts one or more elastic straps or bands 78 as wrapped around the rod blank 100 and anchored by the studs 72 to secure the fishing assistance device 150 to the rod blank 100.

For stability on a fishing rod blank 100, the coupler 52 is shown in FIGS. 6 through 11 as having an elongate shape in a direction parallel to the axis of a rod blank 100 mated to its arcuate surface 53. A suitable longitudinal length of the coupler 52 for this purpose is believed to be greater than twice the distance, for example, approximately four times the distance, between the lateral edges 55 of the arcuate surface 53. Stability is also enhanced as a result of the support arm 58 adjoining the coupler 52 at or near the center of the distance between the longitudinal ends of the coupler 52.

The fishing assistance device 150 further differs from the device 50 of FIGS. 1 through 5 in regard to the shape of the guide arm 64, which includes a slight bend adjacent its distal end 68 to better retain a fishing line 118 on the guide arm 64, further ensuring that the fishing line 118 is more likely to reside within and continuously contact the guide arm 64 of the fishing assistance device 150 at both extreme paths A1 and A2 (FIG. 2) and all locations therebetween. Otherwise, the guide arm 64 of the device 150 is preferably capable of interacting with the fishing line 118 in a manner essentially the same as that described for the device 50 in reference to FIGS. 2, 3A, and 3B.

The fishing assistance device 150 of FIGS. 6 through 11 can be optionally equipped with a hook holder 74 with which a lure or hook can be retained. In the nonlimiting embodiment shown, the hook holder 74 extends from the guide arm 64 and support arm 58 in a direction opposite the guide arm 64, and comprises three lobes 76A, 76B, and 76C, and a slot 78 defined by and between the lobes 76B and 76C is sufficiently sized to receive a hook that is hung on the lobe 76B.

As previously noted above, though the foregoing detailed description describes certain aspects of one or more particular embodiments of the invention, alternatives could be adopted by one skilled in the art. For example, the fishing assistance device 50 and its components could differ in appearance and construction from the embodiments described herein and shown in the drawings, functions of certain components of the door finishing system could be performed by components of different construction but capable of a similar (though not necessarily equivalent) function, and various materials could be used in the fabrication of the door finishing system and/or its components. As such, and again as was previously noted, it should be understood that the invention is not necessarily limited to any particular embodiment described herein or illustrated in the drawings.

1. A fishing assistance device adapted for use in combination with a fishing rod having a rod blank, a spinning reel mounted on the rod blank, and a first guide mounted on the rod blank adjacent the spinning reel, the spinning reel including a spool, a fishing line on the spool and passing through the first guide, and a bail adapted to rotate around the spool to wind the fishing line around the spool, the fishing assistance device comprising:
a coupler configured to removably attach to the rod blank at a location between the spinning reel and the first guide on the rod blank; and
a guide arm supported by the coupler, the guide arm being configured to guide the fishing line so as to alter a path of the fishing line between the first guide and the bail of the spinning reel as the bail rotates around the spool and winds the fishing line around the spool.

2. The fishing assistance device of claim 1, further comprising a support arm connecting the guide arm to the coupler such that the guide arm is spaced apart from the rod blank when the fishing assistance device is coupled to the rod blank with the coupler.

3. The fishing assistance device of claim 1, wherein the coupler has an arcuate shape and an interior passage configured to receive the rod blank.

4. The fishing assistance device of claim 3, wherein the coupler has a circular arc shape having an arc length that is greater than 50% of a circle, an arcuate surface that surrounds more than 50% of a circumference of the interior passage, and a radial access opening to the interior passage that has an arc length that is less than 50% of the circumference of the interior passage.

5. The fishing assistance device of claim 3, wherein the coupler has a circular arc shape having an arc length that is less than 50% of a circle, an arcuate surface whose arc length is less than 50% of a circumference of the interior passage, and a radial access opening to the interior passage that has an arc length that is greater than 50% of the circumference of the interior passage.

6. The fishing assistance device of claim 5, further comprising at least two pairs of opposing studs located adjacent lateral edges of the arcuate surface, and at least one elastic strap configured to be anchored by the two pairs of opposing studs to secure the fishing assistance device to the rod blank.

7. The fishing assistance device of claim 1, wherein the guide arm has a bend adjacent a distal end thereof.

8. The fishing assistance device of claim 1, further comprising a hook holder extending from the guide arm in a direction opposite the guide arm.

9. The fishing assistance device of claim 8, the hook holder comprising lobes and at least one slot defined by and between the lobes and sized to receive a hook hung on one of the lobes.

10. A fishing system comprising:
a fishing rod having a rod blank, a spinning reel mounted on the rod blank, and a first guide mounted on the rod blank adjacent the spinning reel, the spinning reel including a spool, a fishing line on the spool and passing through the first guide, and a bail adapted to rotate around the spool to wind the fishing line around the spool; and
the fishing assistance device of claim 1, the coupler of the fishing assistance device being removably attached to the rod blank at a location between the spinning reel and the first guide on the rod blank, and the guide arm of the fishing assistance device guides the fishing line relative to the rod blank in a manner that alters a path of the fishing line relative to the rod blank between the first guide and the bail as the bail is rotated around the spool and winds the fishing line around the spool.

11. The fishing system of claim 10, wherein the path of the fishing line is altered between two paths that induce a jigging motion in a lure on the fishing line.

12. The fishing system of claim 11, wherein the guide arm engages the fishing line as the bail rotates to alter the path of the fishing line between first and second paths, the first path is between the first guide and a first circumferential location of the bail nearest the rod blank, and the second path is between the first guide and a second circumferential location of the bail farthest from the rod blank.

13. The fishing system of claim 12, wherein the guide arm is configured to engage the fishing line as the bail rotates so that the fishing line accelerates as the bail travels from the first circumferential location to the second circumferential location and the fishing line decelerates as the bail travels from the second circumferential location to the first circumferential location.

14. The fishing system of claim 12, wherein the second path is longer than the first path.

15. The fishing system of claim 12, wherein slack in the fishing line is induced as the path of the fishing line changes between the first and second paths.

16. A method of jigging a fishing lure, the method comprising:
providing a fishing rod having a rod blank, a spinning reel mounted on the rod blank, and a first guide mounted on the rod blank adjacent the spinning reel, the spinning reel including a spool, a fishing line on the spool and passing through the first guide, and a bail adapted to rotate around the spool to wind the fishing line around the spool;
attaching a fishing assistance device to the rod blank between the first guide and the spool and engaging the fishing line with a guide arm of the fishing assistance device; and
rotating a handle of the spinning reel to rotate the bail around the spool and reel in the fishing line;
wherein the guide arm of the fishing assistance device alters a path of the fishing line between the first guide and the bail as the bail rotates around the spool of the spinning reel to cause the fishing line to move in a jigging motion.

17. The method of claim 16, wherein the path of the fishing line is altered between two paths that induce the jigging motion in the fishing line.

18. The method of claim 16, wherein the guide arm engages the fishing line as the bail rotates to alter the path of the fishing line between first and second paths, wherein the first path is between the first guide and a first circumferential location of the bail nearest the rod blank and the second path is between the first guide and a second circumferential location of the bail farthest from the rod blank.

19. The method of claim 18, wherein the guide engages the fishing line as the bail rotates so that the fishing line accelerates as the bail travels from the first circumferential location to the second circumferential location and the fishing line decelerates as the bail travels from the second circumferential location to the first circumferential location.

20. The method of claim 18, wherein the second path is longer than the first path and slack in the fishing line is induced as the path of the fishing line changes between the first and second paths.
